(19) United States
(12) Patent Application Publication
(10) Pub. No.: US 2013/0145828 A1
(43) Pub. Date: Jun. 13, 2013

(54) COLUMN PACKING FOR LIQUID CHROMATOGRAPHY, SEPARATION COLUMN, AND LIQUID CHROMATOGRAPHY DEVICE

(71) Applicants: Masako Kawarai, Hitachinaka (JP); Masahito Ito, Hitachinaka (JP); Norimasa Minamoto, Hitachinaka (JP)

(72) Inventors: Masako Kawarai, Hitachinaka (JP); Masahito Ito, Hitachinaka (JP); Norimasa Minamoto, Hitachinaka (JP)

(73) Assignee: HITACHI HIGH-TECHNOLOGIES CORPORATION, Tokyo (JP)

(21) Appl. No.: 13/818,035

(22) PCT Filed: Aug. 26, 2011
(86) PCT No.: PCT/JP2011/069261

§ 371 Date: Feb. 20, 2013

(30) Foreign Application Priority Data
Aug. 26, 2010 (JP) 2010-189446

(51) Int. Cl. B01J 39/26; G01N 30/50

(52) U.S. Cl. CPC B01J 39/26; G01N 30/50
USPC 73/61.53; 252/184; 210/198.2

(57) ABSTRACT

To provide a column packing, a separation column, an analysis device, and an analysis method to reduce the analysis time without deteriorating the separation of multi-component amino acids. Disclosed are a column packing comprising a core portion made of a styrene-di-vinylbenzene copolymer having a cross-linkage degree of 50% or more and a shell portion made of a styrene-di-vinylbenzene copolymer having a cross-linkage degree of 20% or less; a separation column using the column packing; and a high-speed liquid chromatography analysis device and a analysis method using the separation column.

### TECHNICAL FIELD

The present invention relates to a column packing for a liquid chromatography, specifically the chromatography used for high performance amino acid analysis, a separation column filled with the column packing, and an analysis device using the separation column.

### BACKGROUND ART

A speedup in a high performance liquid chromatography (HPLC) can be achieved by reducing a void time t₀ (s). To minimize t₀ with no separation ability penalty, it is necessary to minimize HETP (height equivalent to a theoretical plate) (μm) at high linear velocity u (mm/s) and also minimize a pressure drop ΔP (MPa) in a column. That is, it is necessary for resistance of the column to be minimized and it is necessary for column permeability Kᵥ (m²) to be maximized. To achieve a column for high performance amino acid analysis, it is necessary to have discussion based on such kinetic plot analysis [NPL 1].

A speedup in the current HPLC has been achieved by microparticulation of a reversed-phase column packing. However, the smaller a particle diameter of the column packing, the higher pressure drop in the column [refer to Non-Patent Document 1]. As a totally-porous column packing, for example, a silica gel column packing having a particle diameter of 1.2 to 1.8 μm is commercially available. According to van Deemter plot, the HETP of the column packing does not easily decrease even if linear velocity is increased, but back pressure in the column increases [refer to Non-Patent Document 2].

There is known a core-shell structured column packing as the column packing capable of reducing pressure drop and achieving a good HETP within a range of high linear velocity [Patent Document 1]. In the totally-porous column packing, a diffusion distance of sample molecules within a column packing particle is equivalent to its diameter. However, in the core-shell structured column packing, since sample molecules do not diffuse in a core portion (Fused-Core (registered trademark) in Patent Document 1), the diffusion distance within a particle is short.

For example, in the case of a core-shell structured column packing with a particle diameter of 2.7 μm wherein a 0.5-μm thick porous silica layer has been formed on the surface of the core portion with a diameter of 1.7 μm, although the back pressure is equivalent to that of a 2.7-μm totally-porous silica column packing, separation performance is equivalent to that of a 1.8-μm totally-porous silica column packing [refer to Patent Document 1]. However, since the skeleton thereof is made of fused silica, pH of an eluent to be used is limited to 3 to 8, but strongly acidic or strongly basic buffer solutions cannot be used. Furthermore, basic substances are adsorbed due to an influence of a silanol group remaining on a surface thereof. Accordingly, it is difficult to elute some acidic amino acids and basic amino acids.

Meanwhile, there is known a polymer core-shell structured column packing made up of a coated polymer particle wherein a hydrophilic polymer layer has been formed on a surface of a hydrophobic cross-linked polymer particle. Since a highly cross-linked polymer is used for the core portion thereof, it is possible to obtain the column packing for liquid chromatography having extremely great mechanical strength and excellent pressure resistance [refer to Patent Document 2]. However, this column packing's analysis target is a high-molecular protein, and the core portion thereof is made up of a porous cross-linked polymer particle. Therefore, low-molecular compounds with a molecular weight of 1,000 or less can comparatively freely permeate the core portion, and it is not possible to inhibit the diffusion of sample solutes namely the peak expansion in chromatography. Thus, in the polymer core-shell structured column packing, the number of theoretical stages stays in low.

Furthermore, the polymer core-shell structured column packing has a material different from a hydrophobic core particle on its outer surface to improve an affinity with a protein. The outer surface is coated with a hydrophilic polymer. Mainly used hydrophilic monomers are an acrylic acid, a methacrylic acid, and the like. For this reason, double polymerization is necessary for polymerizing hydrophobic monomers and polymerizing hydrophilic monomers, which makes the process complicated and results in a tendency of unevenness of column packing quality including variation of retention time. Moreover, since a particle diameter to be intended in the column packing is as large as hundreds of micrometers, the column packing having such a condition are not suitable for analysis of multi-components of amino acid with a molecular weight of several hundred.

### CITATION LIST

### Patent Documents

[Patent Document 1] US2007/0189944A1
[Patent Document 2] Japanese Unexamined Patent Application Publication No. Hei 3 (1991)-73848

### Non-Patent Documents

[Non Patent Document 1] Analytical Chemistry, 77, 4058-4070 (2005)
[Non Patent Document 2] LCGC north America, 12, 124-162 (2001)

### SUMMARY OF INVENTION

### Technical Problem to be Solved

Basic performance required for the high performance liquid chromatograph includes: an analysis in shorter time, which means a fast analysis; and accurate determination for quality and quantity of a plurality of components, namely, which means a high separation. However, those two points of the basic performance are conflicting with each other. In the high performance liquid chromatogram, when the velocity of a mobile phase is increased to realize the fast analysis, the number of theoretical stages decreases; whereas, in order to realize the high separation, it is necessary to ensure the sufficient number of theoretical stages by having sufficient analysis time. As factors that make it difficult to satisfy both the high separation analysis and the fast analysis, characteristics of the column packing significantly contribute, because they affect performance (the height equivalent to a theoretical plate, liquid feeding property, and column permeability) of the separation column.

### Solution to Problem

The present invention relates to a column packing for liquid chromatography, and the column packing basically comprises a shell with certain permeability for a specific sample molecule and a core with lower permeability (including non-permeability) than that of the shell for the specific sample molecule, wherein the core is covered with the shell of a polymer coating.

Herein, each permeability of the core and shell in the column packing means a property in which a sample permeates the core or shell, while column permeability is an index indicating performance of the column and is different from the permeability of the core or shell in the column packing.

Preferably, for example, each core is made of a particle in which a surface of a polymer core is covered by a polymer shell.

More preferably, both the shell and the core are styrene-di-vinylbenzene copolymers, and the degree of cross-linkage is different so as to provide the aforementioned certain permeability and lower permeability, respectively. Furthermore, the shell is a styrene-di-vinylbenzene copolymer incorporating a functional group (e.g., strongly acidic cation-exchange group).

More preferably, for example, the column packing is made of particles each created such that the surface of a styrene-di-vinylbenzene copolymer having a cross-linkage degree of 50% or more is covered with a styrene-di-vinylbenzene copolymer having a cross-linkage degree of 20% or less (including 0%) which incorporates a strongly acidic cation-exchange group. Furthermore, there are provided a separation column using the aforementioned column packing, a liquid chromatography analysis device, and a liquid chromatography analysis method.

Furthermore, the following are proposed as a core material and a shell base material of the column packing:

[Core Material]

As a core portion, other than the aforementioned styrene-di-vinylbenzene copolymer, polymethacrylate, polyvinyl alcohol, polyhydroxy methacrylate, polyacrylate, polyvinyl alcohol, polyether, (meta)acrylate series, vinyl alcohol series, acrylamide series, methacrylic acid series, and acrylic acid series can be used.

Polymer series plastics, such as styrene-di-vinylbenzene copolymer and polymethacrylate, exert high chemical resistance when an alkaline solution is used for a mobile phase.

Those materials are suitable for such occasions that strong alkali is used for cleaning the column when analyzing protein or amino acid by means of an ion exchange. A variety of polymers increase the range of options for a mobile phase, and acidic, alkaline, polar organic solvents and also nonpolar organic solvents are widely applicable. Furthermore, for sample molecules, both hydrophilic polymers and hydrophobic polymers are applicable.

Other materials that can be used for the core portion include inorganic materials such as hydroxyapatite, alumina, carbon, and silica gel; metals such as titanium, stainless steel, and platinum; ceramics such as alumina and titania; (super) engineering plastics such as PEEK material (polyether etherketone); fluorine resins such as PTFE and PFE; and synthetic jewels such as diamond and sapphire.

Since metals such as titanium, stainless steel and platinum, and PEEK materials have a chemical resistance against many organic compounds, they are applicable for various mobile phases. However, it is known that they are not conformable to concentrated nitric acid or concentrated acetic acid.

When using a metal material for the core, preferably, inactivation treatment is performed on the surface of the core to prevent adsorption of sample molecules; and more preferably, multilayered inactivation treatment may be performed in some cases.

When silica gel is used as a core material, preferably, silylation treatment or silane treatment may be performed to increase surface inertness for the core.

[Shell Functional Group]

Another embodiment proposes a carboxylic acid group (—COOH) as the weak cation-exchange group. Furthermore, there are proposed column packings for anion-exchange chromatography.

As a material for covering the surface of the styrene-di-vinylbenzene copolymer having a cross-linkage degree of 50% or more, proposed may be a styrene-di-vinylbenzene copolymer having a cross-linkage degree of 20% or less (including 0%) which incorporates an anion-exchange group.

Trimethylammonium group R—N⁺(CH3)3 is a strong anion-exchanger resin, and dimethyl ethanol ammonium group R—N+(CH3)2.CH2CH20H is a weak anion-exchanger resin. The above are so-called functional groups for ion exchange chromatography.

Furthermore, there are proposed column packings for reversed-phase chromatography. Representative column packings are C18, C8, C4, C30, and C1 (trimethylsilane: TMS). Phenyl group, cyano group, amino group, and PFP (pentafluorophenyl) group are also proposed.

As column packings for normal-phase chromatography, proposed are diol, glyceropropyl group, aminopropyl group, cyanopropyl group, and the silanol group.

Furthermore, proposed may be a column packing for ZIC-HILIC having an ampholyte ion as a functional group (quaternized amine-sulfonic acid).

In the case of ion pair chromatography, an ion pair reagent is added to a mobile phase by use of a column packing for reversed-phase chromatography. In the case of ligand exchange chromatography, a metal ion and a competitive ligand are added to a mobile phase by use of a column packing for ion exchange chromatography.

In the case of hydrophobic interaction chromatography, a functional group, such as a phenyl group, octyl group, butyl group, hexyl group, oligoethylene glycol group, propyl group, and a methyl group, is bound with the shell.

In the case of affinity chromatography, a functional group, such as boronate, heparin, aminobenzamidine, Cibacrone Blue F3G-A, iminodiacetic acid, a tresyl group, and antibody, is immobilized on the shell.

In the case of chemoaffinity chromatography, a functional group, such as alumina, titania, zirconia, cyclodextrin, triptophan residue, and ethylene diamine tetraacetic acid related substances, is immobilized on the shell.

In the case of chiral separation chromatography, a chiral selector, such as chiral crown ether, is bound with the shell.

In the case of size exclusion chromatography, not a functional group but a certain bore (pore) is provided for the shell portion while keeping non-permeability of the core portion.

### Advantageous Effects of Invention

According to the present invention, it is possible to satisfy both the high separation analysis and the fast analysis by improving characteristics of the column packing to thereby improve the column functions (the height equivalent to a theoretical plate, liquid feeding property, and column permeability).

Specifically, as shown in a preferred example, when using a polymer with high cross-linkage for the core portion, mechanical strength is extremely great and an ion-exchange group (e.g., sulfone group) does not exist in the core portion. Therefore, neither swelling nor constriction occurs, and it is possible to obtain a column packing for liquid chromatography having excellent pressure resistance. Furthermore, since the shell portion is a thin porous that allows analysis target samples to permeate, fast analysis is possible.

### BRIEF DESCRIPTION OF DRAWINGS

FIG. 1 is a system configuration diagram of the high-speed liquid chromatograph according to the present invention.

FIG. 2 is a flow channel configuration diagram of the system of the high-speed liquid chromatograph according to the present invention.

FIG. 3 is a cross-sectional schematic diagram of a column packing according to the present invention.

FIG. 4 is a graph illustrating a relationship each between HETP and linear velocity in a separation column filled with the column packing according to the present invention and a column filled with a conventional column packing.

FIG. 5 shows a composition of ninhydrin reagent.

FIG. 6 shows a composition of buffer solution used for a protein hydrolysate analysis method.

FIG. 7 shows analytical conditions for a protein hydrolysate analysis method.

FIG. 8 is a chromatogram by means of the protein hydrolysate analysis method using the separation column according to the present invention.

FIG. 9 shows a composition of the buffer solution used for physiological fluid analysis.

FIG. 10 shows analytical conditions used for the physiological fluid analysis.

FIG. 11 is a chromatogram by means of the physiological fluid analysis method using the separation column according to the present invention.

### DESCRIPTION OF EMBODIMENTS

In a preferred embodiment of the present invention, an ion-exchange group such as a sulfone group is not formed in the core portion of the column packing, whereas a desired ion-exchange group is formed in the shell portion. Since the core portion is denser and stronger than the shell portion, it is possible to increase mechanical strength of the column packing. Because sample molecules do not diffuse in the core portion, sulfonic acid which is an ion-exchange group does not have to be incorporated. In the shell portion, an ion-exchanger resin to separate amino acid is chemically modified. Preferably, for example, the particle diameter of the column packing is 2 to 4 μm, particularly about 3 μm, and the thickness of the shell is 0.5 to 1.0 μm. This is because, speaking in the extreme, when the shell is 0 μm thick, that is, when the column packing has only a core portion, there is no so-called stationary-phase volume and loading volume of sample molecules cannot be ensured. The thickness of the shell is preferably 0.5 to 1.0 μm to ensure a certain level of the ratio of the stationary phase.

The column packing according to the present invention can be applied to the separation column for liquid chromatography, and also to the liquid chromatography analysis method and the analysis device using the separation column. The liquid chromatography analysis method is an analysis method for simultaneously separating multi-component amino acids and measuring the concentration.

In the column packing for liquid chromatography, in particular, which is preferable to chemically modify a sulfone group (—SO₃H) in the shell layer of the column packing as a strong ion-exchange group.

The present invention provides a liquid chromatography analysis method in which an acidic eluent is fed to the separation column filled with the aforementioned column packing by a salt concentration gradient elution method and used as a separation field of the liquid chromatography.

Furthermore, the present invention provides a liquid chromatography analysis method in which an eluent is fed to the aforementioned column packing by a hydrogen-ion exponent (pH) gradient elution method and used as a separation field of the liquid chromatography.

Furthermore, the present invention provides a liquid chromatography device used for an analysis device for simultaneously separating a plurality of amino acid components and measuring the concentration of them, the liquid chromatography device comprising a separation column, a sample feeding pump, an sample injector, a column oven, a detector, and a central processing unit for at least controlling the pump and the detector and processing data, wherein the column oven is provided with a separation column filled with a column packing made of particles each created such that the surface of the styrene-di-vinylbenzene copolymer core having a cross-linkage degree of 50% or more is covered by a styrene-di-vinylbenzene copolymer shell having a cross-linkage degree of 20% or less (including 0%) and incorporating a strongly acidic cation-exchange group.

Preferably, the separation column of the liquid chromatography device has a height equivalent to a theoretical plate H (μm) of 10×d_{S} or less when using the average shell thickness d_{S} (μm).

The present invention provides a liquid chromatography analysis method in which an organic solvent of 1% or more is added to an eluent fed to the aforementioned column packing and used as a separation field of the liquid chromatography.

Preferably, the styrene-di-vinylbenzene copolymer column packing for liquid chromatography has a double structure configuring a core portion and a shell portion, wherein the core portion does not allow molecules with a molecular weight of 75 or more (e.g., glycine) to permeate, and the shell portion allows molecules with a molecular weight of less than 75 to permeate. Herein, “to allow molecules to permeate” means that molecules can pass through under the liquid chromatographic conditions. Herein, in an example of the present invention, as described above, the core portion does not allow molecules with a molecular weight of 75 or more to permeate, and the shell portion allows molecules with a molecular weight of less than 75 to permeate. This is because cross-link densities of styrene-di-vinylbenzene copolymers of the core portion and the shell portion, which constitute the column packing, differ from each other. In the present invention, for a sample molecule having a specific molecular weight (so-called specific sample molecule), the core portion has low permeability (including non-permeability) and the shell portion has permeability. With respect to this, the molecular weight for the acceptable standard of permeation is not intended to be limited to 75 as mentioned above, and it can be set to any value by arbitrarily adjusting the cross-link density of the core and the shell.

Furthermore, preferably, the aforementioned styrene-di-vinylbenzene copolymer column packing for liquid chromatography has a double structure configuring a core portion and a shell portion, wherein the core portion does not allow amino acid molecules to permeate and the shell portion allows amino acid molecules to permeate. This configuration is possible because cross-link density of the core portion and that of the shell portion are made so as to be different from each other.

In the present invention, the core portion preferably has low permeability. That is, preferably, volume Vc of the core portion of the aforementioned styrene-di-vinylbenzene copolymer column packing for liquid chromatography is 10% or more of the total (spherical) volume of the column packing, and the total volume of the pores in the core portion is 10% or less of Vc.

Furthermore, preferably, the aforementioned styrene-di-vinylbenzene copolymer column packing for liquid chromatography has a double structure configuring a core portion and a surface shell portion, wherein particle diameter d_{P} is 4 μm or less, and the diameter of the core portion is more than or equal to ½ times the particle diameter d_{P}. The average particle diameter of the column packing d_{P} being 3 to 4 μm is a requirement for establishing Kᵥ>5×10⁻¹⁵ and the shell thickness d_{S} being up to 1 μm is a requirement for establishing H<5 μm or less. However, it is not clear whether their respective parameters d_{P} and d_{S} independently act on the pressure drop and the height equivalent to a theoretical plate.

Moreover, preferably, in the spherical column packing, its column permeability Kᵥ m²) is 1×10⁻¹⁵×(d_{P}/3)² or more when using average particle diameter d_{P} (μm). Furthermore, preferably, in the spherical column packing, its height equivalent to a theoretical plate H (μm) is 10×d_{S} or less when using average shell thickness d_{S} (μm).

The column packing according to the present invention is used for a separation column for liquid chromatography and is made up of coated polymer particles (core-shell structured column packing) each created such that a porous shell layer made of a styrene-di-vinylbenzene copolymer or the like is formed on an outer surface of a high cross-linkage hydrophobic polymer particle as the core.

Specifically, mechanical strength is increased by using a styrene-di-vinylbenzene copolymer having a cross-linkage degree of 50% to 80%, which is a high cross-linked polymer, for the core portion. Furthermore, a styrene-di-vinylbenzene copolymer having a cross-linkage degree of 20% or less is used for the shell portion. Herein, the degree of cross-linkage means the mol percent of di-vinylbenzene in the styrene-di-vinylbenzene copolymer.

In the column packing according to the present invention, since sample molecules do not diffuse into the core portion, sulfonic acid which is an ion-exchange group does not have to be incorporated. The shell portion is made up of a low cross-link density styrene-di-vinylbenzene copolymer having an ion-exchange group to separate amino acid.

With regard to structural parameters of the ion-exchanger resin for amino acid analysis, Table 1 shows the parameters of the conventional totally-porous ion-exchanger resin and the parameters of the core-shell structured column packing (ion-exchanger resin) according to an example of the present invention.

TABLE 1
Structural parameters of the ion-exchanger resin for amino
acid analysis

| | | Totally-porous | Core-shell |
|---|---|---|---|
| No. | Parameter | (conventional) | structured |
| 1 | Particle diameter (μm) | 3 | 3 |
| 2 | Shell thickness (μm) | 3 | 1 |
| 3 | Pore (nm) | 10 | 10 |
| 4 | Matrix material | Polystyrene | Polystyrene |
| | | series | series |
| 5 | Ion-exchange group | Sulfonic acid | Sulfonic acid |

The core portion according to an example of the present invention since has a high cross linkage and a small diameter of pores, the sample does not diffuse therein. Therefore, the diffusion pathway within the particle is short, and the height equivalent to a theoretical plate HETP does not easily change even if linear velocity of the column (chromatography device) is increased.

The particle diameter of this example is nearly 3 μm, resulting in that the column permeability is the same as the conventional column permeability. However, in the nearly 1-μm thick shell portion, since substances quickly move therein, provided is a more excellent height equivalent to a theoretical plate HETP than the conventional height.

According to the present invention, separation performance of the column does not deteriorate in the amino acid analysis even if flow velocity is increased, it is possible to reduce the time required for conventional analysis to about one-third. For example, conventionally, it took 30 minutes (cycle time: 53 minutes) to analyze 19 components of standard amino acid by use of an amino-acid analyzer, whereas it takes 10 minutes (cycle time: 20 minutes) to conduct the same analysis.

Next, an example will be described in detail with reference to the drawings.

### Example 1

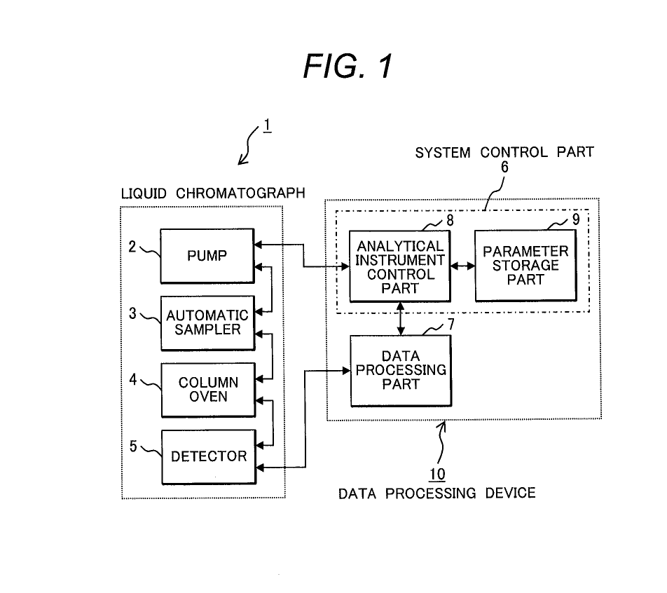

FIG. 1 is an example of system configuration of the liquid chromatograph according to the present invention. The liquid chromatograph device 1 comprises a pump 2 of an analytical instrument module, an automatic sampler (sample injector) 3, a column oven 4 containing a separation column, a detector 5, and a data processing device 10.

The data processing device 10 comprises a system control part 6 and a data processing part 7, and the system control part 6 is made up of an analytical instrument control part 8 and a parameter storage part 9. At the time of analysis, the system control part 6 of the data processing device 10 issues commands, and a series of parameter groups for the analysis sequence are sent (downloaded) to the pump 2 of each module, automatic sampler 3, column oven 4, and the detector 5. Every time a sample is injected, the data processing part 7 digitally receives detection signals from the detector 5, forms the signals into chromatogram waveforms, and analyzes the data.

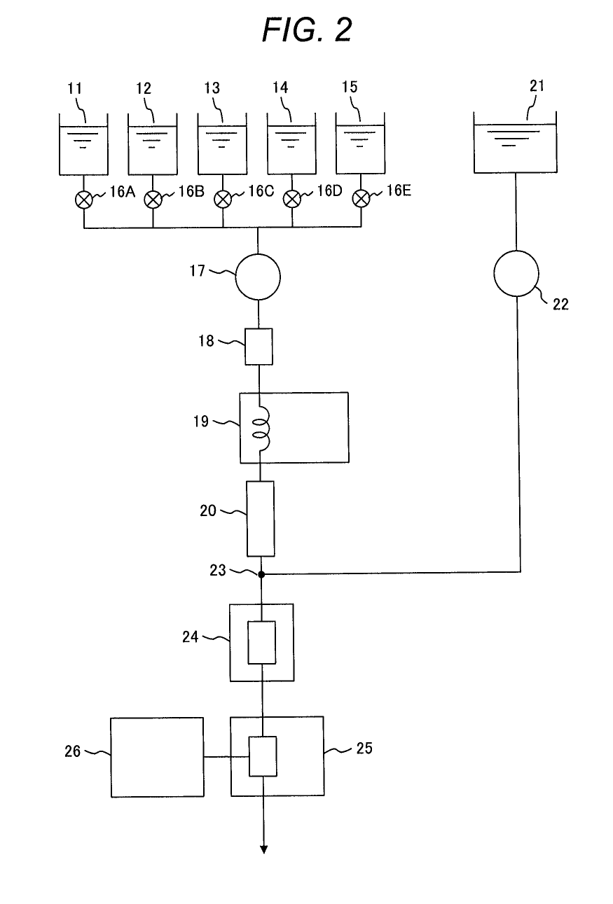

FIG. 2 is an example of the device configuration and flow channel configuration of the amino-acid analyzer according to this example. There are provided first to fourth buffer solutions 11 to 14, and a column regenerating solution 15. From those, a buffer solution used as an eluent by the electromagnetic valve series 16 is selected, and the amino acid sample provided by the buffer solution pump 17 through the ammonia filter column 18 and the automatic sampler 19 is separated by the separation column 20. The thus separated amino acid is mixed by a mixer 23 with a ninhydrin reagent 21 sent by a ninhydrin pump 22, and reacts in the heated reaction column 24.

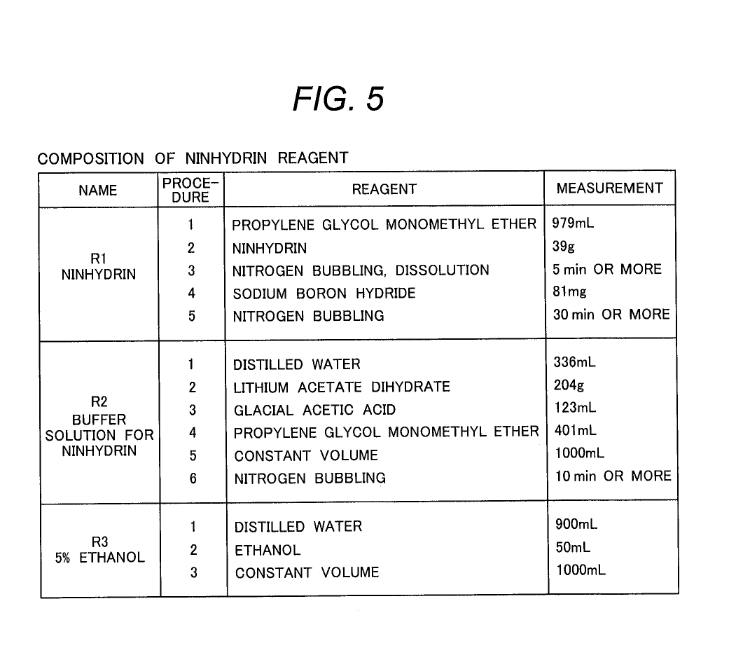

FIG. 5 shows the composition of ninhydrin reagent. The ninhydrin reagent is made such that ninhydrin and a ninhydrin buffer solution are mixed together at a ratio of 1:1. The amino acid that has exerted a color (Ruhemann's purple) due to reaction is continuously detected by the detector 25, outputted as chromatogram and data by the data processing device 26, and saved as records.

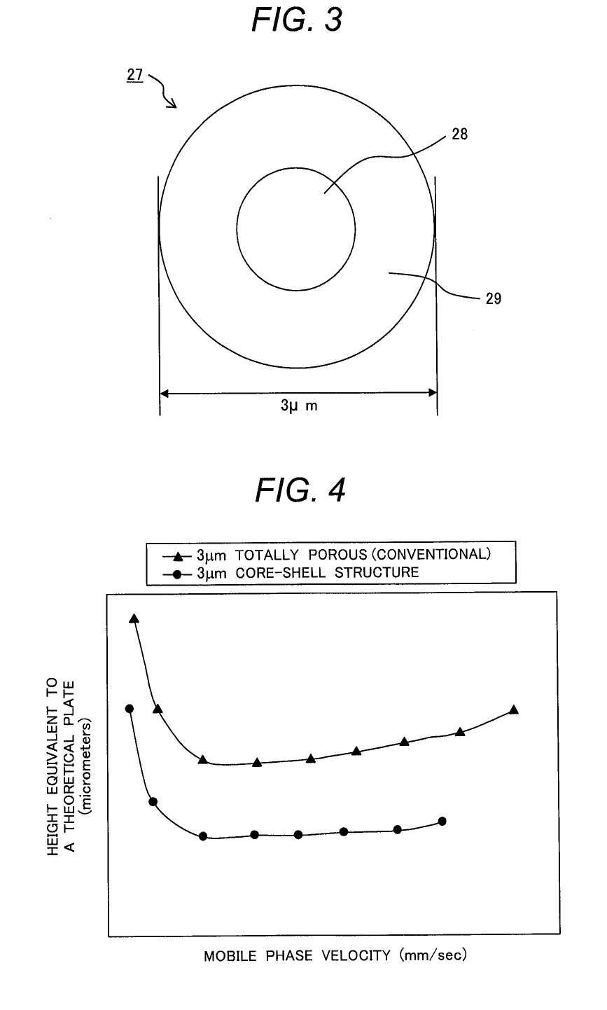

When conducting amino acid fast analysis by use of the device shown in FIG. 2, use is a separation column filled with a core-shell structured ion-exchanger resin 27 shown in FIG. 3. The core-shell structured ion-exchanger resin 27 is a column packing with a particle diameter of about 3 μm, wherein an about 1-μm thick porous shell 29 is formed on the surface of the core 28 made of di-vinylbenzene-polystyrene copolymer with a diameter of about 2 μm and a cross-linkage degree of 50%. The shell is made of an ion-exchanger resin that incorporates sulfonic acid as an ion-exchange group.

FIG. 4 shows a relationship each between the column's height equivalent to a theoretical plate HETP (μm) and linear velocity u (mm/s) when using a core-shell structured ion-exchanger resin according to the present invention in the aforementioned system and when using a conventional ion-exchanger resin having a particle diameter of 3 μm. In the case of the use of the core-shell structured ion-exchanger resin, when compared with the case in which a conventional ion-exchanger resin having the same particle diameter is used, it is found that the HETP does not increase as the linear velocity increases and separation does not easily deteriorate.

The ion-exchanger resin used for separation of amino acid is a strong ion-exchanger resin wherein a sulfonic acid group has been chemically modified. Generally, there are used two amino acid analysis methods: a method of separating and quantifying approximately 20 components of amino acid obtained as hydrolysate of protein, and a method of separating and quantifying approximately 40 components of free amino acid and related substances contained in the physiological fluid, such as blood serum and urine. To thus separate multi-components, it is necessary to optimize separation condition parameters by taking into consideration the physical properties (dissociation constant: pK_{1(COOH)}, isoelectric point: pl) of each amino acid and the hydrophobic interaction between benzene nucleus of the ion-exchanger resin and alkyl group of amino acid.

The condition parameters that affect separation include the composition (salt concentration, pH, organic solvent concentration) of the mobile-phase eluent, column temperature, and a flowrate of the eluent. Sodium citrate series buffer solutions are commonly used for the eluent for the protein hydrolysate amino acid analysis method, and lithium citrate series buffer solutions are commonly used for the eluent for the physiological fluid amino acid analysis method. Since both analysis methods elute a large number of components, several kinds of buffer solutions having different pH, salt concentration, and organic solvent concentration are used in turn to conduct analysis.

When switching buffer solutions, there are two available methods: a stepwise elution method and a gradient elution method. The former instantaneously switches solutions and the latter slowly switches solutions for a certain time duration so that specific concentration gradient can be obtained. In the latter method, it is possible to change pH of the eluent, salt concentration, and organic solvent concentration by mixing several kinds of buffer solutions. Changing pH of the eluent will change dissociation of each component of amino acid. By increasing salt concentration, it is possible to reduce the retention time of each amino acid except for specific components such as cystine. By adding an organic solvent to the eluent, it is possible to inhibit the influence of the hydrophobic interaction.

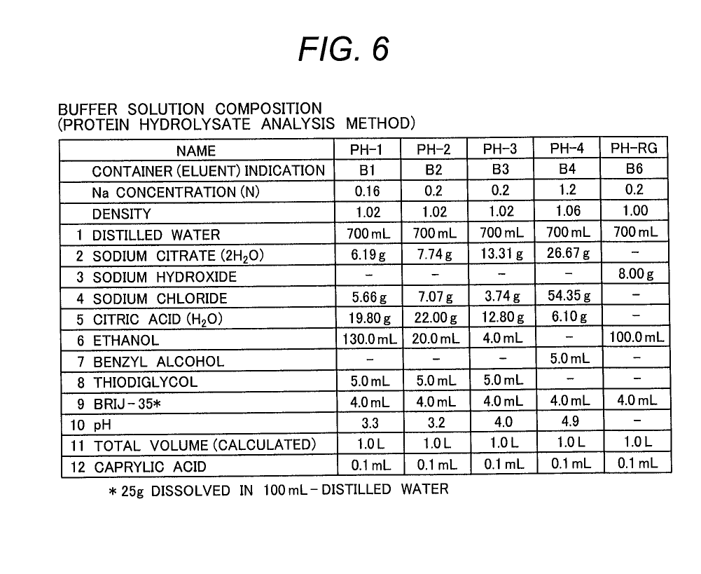

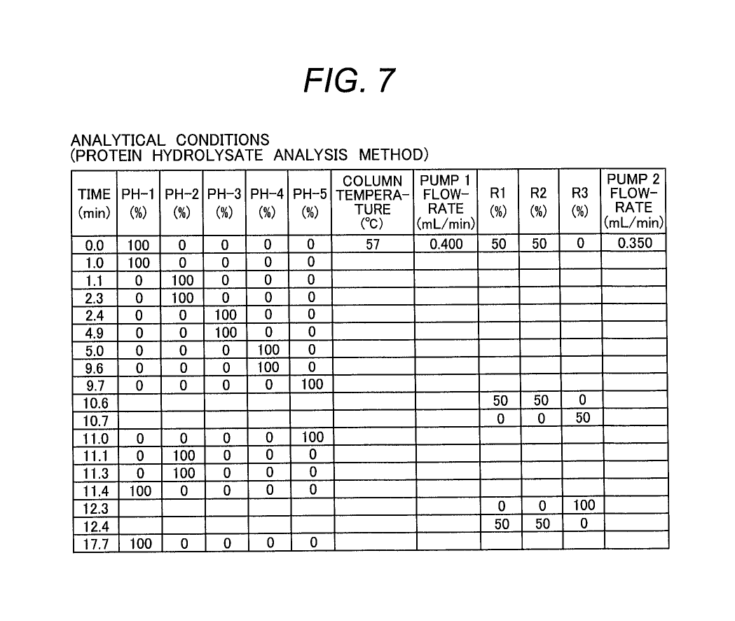

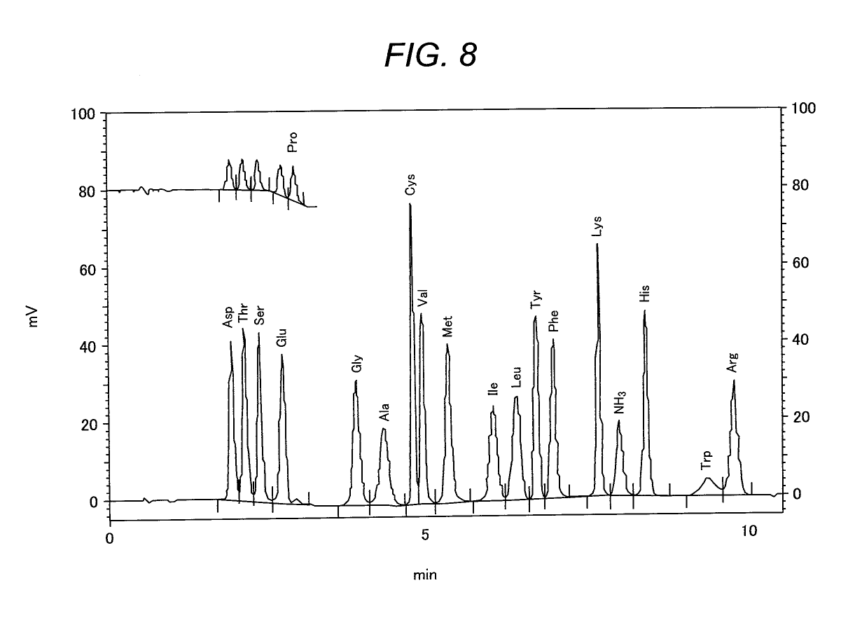

The aforementioned condition parameters were optimized, and 19 components of the protein hydrolysate amino acid standard sample were measured by using the separation column filled with the core-shell structured column packing according to an example of the present invention. FIG. 6 shows the composition of the buffer solutions used. By using a single solution of those or by mixing the solutions, composition of the eluent was optimized. Then, by switching buffer solutions under the analytical conditions shown in FIG. 7, it was possible to separate each component. Buffer solutions were switched by the stepwise elution method, and analysis was conducted with constant temperature and constant flowrate (mL/min). The process after 11 minutes is to clean and regenerate the column. FIG. 8 shows the chromatogram that has been measured, under the analytical conditions shown in FIG. 7, by using buffer solutions shown in FIG. 5 and a separation column wherein a 60-mm long empty stainless-steel column with an inner diameter of 4.6 mm had been filled with the core-shell structured column packing according to the present invention. For each peak in FIG. 8, abbreviation of each amino acid is described, and components are as follows:

That is, asparagine acid (Asp), threonine (Thr), serine (Ser), glutamic acid (Glu), proline (Pro), glycine (Gly), alanine (Ala), cystine (Cys), valine (Val), methionine (Met), isoleucine (Ile), leucine (Leu), tyrosine (Tyr), phenylalanine (Phe), lysine (Lys), ammonia (NH₃), histidine (His), triptophan (Trp), and arginine (Arg).

In the analysis method that uses a conventional ion-exchanger resin with a particle diameter of 3 μm, speeding up of analysis time has been attempted. The analysis time is the time duration until all peaks elute, and the cycle time is the time duration which includes the time for cleaning the flow channel and regenerating the ion-exchanger resin in addition to the analysis time. To clean the flow channel and regenerate the column, after the last component eluted from the column, the buffer solution that was used at the beginning of the analysis was restored, and a regenerating solution R3 shown in FIG. 5 is fed instead of a ninhydrin reagent, and an equally sized separation column filled with a conventional totally-porous ion-exchanger resin was used. At that time, the analysis time was 30 minutes, and the cycle time was 53 minutes. When the separation column filled with a core-shell structured ion-exchanger resin according to the present invention was used, the analysis time was reduced to 10 minutes, and the cycle time was reduced to 18 minutes.

Table 2 shows the characteristic parameters when the conventional totally-porous ion-exchanger resin with a particle diameter of 3 μm was used for the separation column and when a core-shell structured ion-exchanger resin according to an example of the present invention was used for the separation column. Table 2 shows the comparison of the characteristic parameters (withstanding pressure: 20 MPa upper limit). According to this example, although column permeability Kᵥ (m²) is the same as the conventional column permeability, when the core-shell structured column packing was used for the separation column, the linear velocity u of the column doubled, the height equivalent to a theoretical plate HETP was halved, and the void time t₀ became one-sixth compared with the conventional column.

TABLE 2
Comparison of characteristic parameters (withstanding
pressure: 20 MPa upper limit)

| | | Totally-porous | Core-shell |
|---|---|---|---|
| No. | Parameter | (conventional) | structured |
| 1 | Height equivalent to a | 10 | 5 |
| | theoretical plate HETP | | |
| | (μm) | | |
| 2 | Linear velocity u | 2 | 6 |
| | (mm/s) | | |
| 3 | Column permeability Kᵥ | 5 × 10⁻¹⁵ | 5 × 10⁻¹⁵ |
| | (m²) | | |
| 4 | Number of theoretical | 5000 | 5000 |
| | stages N | | |
| | (nondimensional) | | |
| 5 | Void time t₀ (s) | 30 | 5 |

The column permeability Kᵥ (m²) is almost dominated by the particle diameter d_{P} of the core-shell structured column packing. However, to obtain a good (low) height equivalent to a theoretical plat HETP in the column's high linear velocity area (4 mm/s or more), thickness d_{S} of the core-shell structured shell needs to be as small as possible. Practically, it is preferable that the particle diameter d_{P} be nearly 3 μm, and the thickness d_{S} of the shell be 0.5 to 1.0 μm.

### Example 2

An index for the separation in the amino acid analysis is the resolution of isoleucine (Ile) and leucine (Leu) that are most difficult to separate. The time for analyzing 19 components of protein hydrolysate amino acid by the post-column fully-automatic amino-acid analyzer using a conventional cation exchange column was 30 minutes (the cycle time including column regeneration was 53 minutes) when resolution of Ile/Leu was 1.2 or more and 80 minutes (the cycle time including column regeneration was 130 minutes) when resolution of Ile/Leu was 1.5 or more. In contrast, the analysis time when the core-shell structured ion exchange column according to the present invention was used was 10 minutes when the resolution of Ile/Leu was 1.2 or more and approximately 27 minutes when the resolution of Ile/Leu was 1.5 or more.

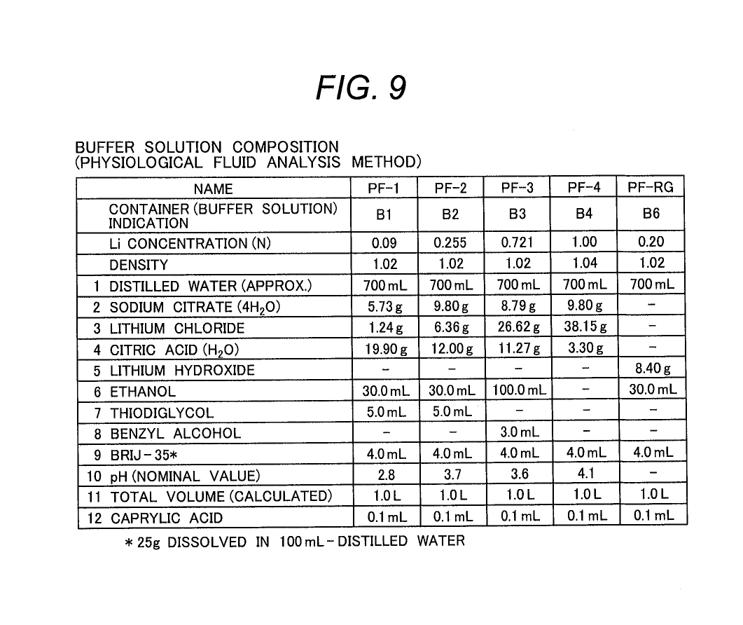

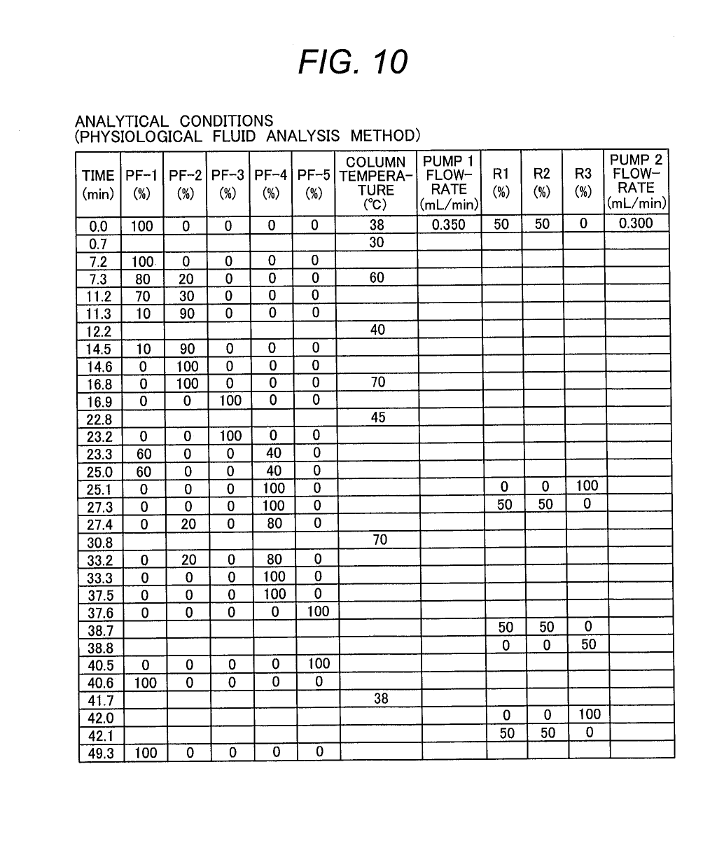

Analysis of 42 components of physiological fluid amino acid was conducted by using a separation column which was a 60-mm long stainless-steel column with an inner diameter of 4.6 mm filled with the core-shell structured ion-exchanger resin according to this example. FIG. 9 shows the composition of buffer solutions used. The buffer solutions were switched by the gradient elution method as shown in FIG. 10. That is, the mixture ratio which was PF-1/PF-2=80/20 at the time of 7.3 minutes was linearly changed so that the ratio becomes 70/30 before 11.2 minutes. Other buffer solutions were switched by the stepwise elution method.

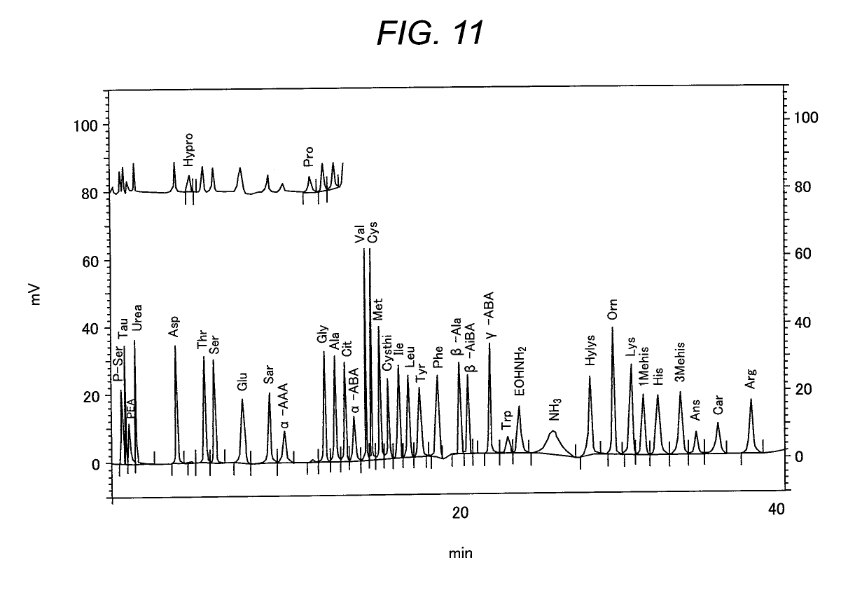

Column temperature conditions were switched by the stepwise method. The flowrate (mL/min) was made constant. The data for 37.6 minutes and onwards indicates the process for cleaning and regenerating the column. FIG. 11 shows the chromatogram. When a conventional column was used, the analysis time was 115 minutes (the cycle time was 148 minutes). However, when the column according to the present invention was used, the analysis time was reduced to 40 minutes (the cycle time was 49.3 minutes). Thus, the use of the core-shell structured ion exchange column makes it possible to reduce the analysis time to approximately one-third.

For each peak in FIG. 11, abbreviation of each amino acid is described, and components are as follows:

Phosphoserine (P-Ser), taurine (Tau), Phosphoethanolamine (PEA), urea (Urea), asparagine acid (Asp), hydroxyproline (Hypro), threonine (Thr), serine (Ser), asparagine (AspNH₂), glutamic acid (Glu), glutamine (GluNH₂), sarcosine (Sar), α-aminoadipic acid (α-AAA), proline (Pro), glycine (Gly), alanine (Ala), citrulline (Cit), α-amino-n-butyric acid (α-ABA), valine (Val), cystine (Cys), methionine (Met), cystathionine (Cysthi), isoleucine (Ile), leucine (Leu), tyrosine (Tyr), phenylalanine (Phe), β-alanine (3-Ala), β-aminoisobutyric acid (β-AiBA), γ-amino-n-butyric acid (γ-ABA), ethanolamine (EOHNH₂), ammonia (NH₃), hydroxylysine (Hylys), ornithine (Orn), 1-methyl histidine (1Mehis), histidine (His), 3-methyl histidine (3Mehis), lysine (Lys), triptophan (Trp), anserine (Ans), carnosine (Car), and arginine (Arg).

### INDUSTRIAL APPLICABILITY

The present invention can be applied to a column packing for liquid chromatography, specifically liquid chromatography used for high-speed amino acid analysis; a separation column filled with the column packing; and an analysis device and analysis method using the separation column.

### REFERENCE SIGNS LIST

1 . . . high performance liquid chromatograph, 2 . . . pump, 3 . . . automatic sampler, 4 . . . column oven, 5 . . . detector, 6 . . . system control section, 7 . . . data processing part, 8 . . . analytical instrument control part, 9 . . . parameter storage part, 10 . . . data processing device, 11 to 14 . . . buffer solution, 15 . . . regenerating solution, 16A to 16E . . . electromagnetic valve series, 17 . . . buffer solution pump, 18 . . . ammonia filter column, 19 . . . automatic sampler, 20 . . . separation column, 21 . . . ninhydrin reagent, 22 . . . ninhydrin pump, 23 . . . mixer, 24 . . . reaction column, 25 . . . detector, 26 . . . data processing device and system control device, 27 . . . core-shell structured ion-exchanger resin, 28 . . . core, 29 . . . porous shell

1. A column packing for liquid chromatography comprising:
a shell with certain permeability for a specific sample molecule; and
a core with lower permeability than that of the shell for the specific sample molecule,
wherein the core is covered with the shell of a polymer coating.

2. The column packing according to claim 1, wherein the core is made of a polymer.

3. The column packing according to claim 1, wherein both the shell and the core are styrene-di-vinylbenzene copolymers and have different cross-linkage degrees to provide the certain permeability and lower permeability, respectively.

4. The column packing according to claim 1, wherein the core is a styrene-di-vinylbenzene copolymer core, and the shell is a styrene-di-vinylbenzene copolymer shell incorporating a functional group.

5. The column packing according to claim 1, wherein the core is made of a styrene-di-vinylbenzene copolymer having a cross-linkage degree of 50% or more.

6. The column packing according to claim 1, wherein the shell is made of a styrene-di-vinylbenzene copolymer having a cross-linkage degree of 20% or less.

7. The column packing according to claim 1, wherein the shell is a styrene-di-vinylbenzene copolymer retaining a strongly acidic cation-exchange group, and the core is a styrene-di-vinylbenzene copolymer not retaining said strongly acidic cation-exchange group.

8. The column packing according to claim 7, wherein the strongly acidic cation-exchange group is a sulfone group (—SO3H).

9. The column packing according to claim 1, wherein both the core and the shell are styrene-di-vinylbenzene copolymers, the shell has permeability for a molecule having a molecular weight of less than 75, and the core has lower permeability than that of the shell for a molecule having a molecular weight of 75 or more.

10. The column packing according to claim 9, wherein both the core and the shell are styrene-di-vinylbenzene copolymers, the core has cross-link density that does not allow an amino acid molecule to permeate, and the shell has cross-link density that allows an amino acid molecule to permeate.

11. The column packing according to claim 9, wherein the column packing is spherical, volume Vc of the core is 10% or more of the total volume of the column packing, and the total volume of pores of the core portion is 10% or less of Vc.

12. The column packing according to claim 9, wherein the column packing is a spherical particle, particle diameter d_{P} is 4 μm or less, and the diameter of the core is more than or equal to ½ times d_{P}.

13. The column packing according to claim 9, wherein the column packing is a spherical particle, and its column permeability Kᵥ(m²) is 1×10⁻¹⁵×(d_{P}/3)² or more when the column packing is filled in a separation column by using average particle diameter d_{P} (μm).

14. The column packing according to claim 9, wherein the column packing is spherical, and its height equivalent to a theoretical plate H (μm) is 10×d_{S} or less by using average shell thickness d_{S} (μm).

15. A column packing for liquid chromatography, made up of a particle in which a surface of a styrene-di-vinylbenzene copolymer core having a cross-linkage degree of 50% or more is covered by a styrene-di-vinylbenzene copolymer shell having a cross-linkage degree of 20% or less.

16. The column packing according to claim 15, wherein the shell incorporates a functional group.

17. The column packing according to claim 16, wherein the functional group is an ion-exchange group.

18. A separation column filled with a column packing according to claim 15.

19. A separation column for liquid chromatography, filled with a column packing as a stationary-phase wherein the column packing is configured such that a core is covered with a shell of a polymer coating, the shell has permeability for a specific sample molecule, and the core has lower permeability than that of the shell.

20. A liquid chromatography device used for an amino acid analysis device to separate a plurality of amino acid components and measure concentration of them, in which a pump for feeding a buffer solution, a sample injector, a column oven and a detector are disposed sequentially; and the device including a central processing unit for controlling the pump and the detector and processing data, wherein
a separation column mounted in the column oven is filled with a column packing comprising particles each created such that a surface of a styrene-di-vinylbenzene copolymer core having a cross-linkage degree of 50% or more is covered by a styrene-di-vinylbenzene copolymer shell having a cross-linkage degree of 20% or less (including 0%).
